(19) United States
(12) Patent Application Publication
(10) Pub. No.: US 2024/0130832 A1
(43) Pub. Date: Apr. 25, 2024

(54) METHOD FOR PRODUCING A WORKING AREA FOR A ROOT CANAL INSTRUMENT AND FOR PRODUCING A ROOT CANAL INSTRUMENT, AND ROOT CANAL INSTRUMENT

(71) Applicant: GEBR. BRASSELER GMBH & CO. KG, Lemgo (DE)

(72) Inventor: Michael KRUMSIEK, Lemgo (DE)

(21) Appl. No.: 18/277,845

(22) PCT Filed: Jan. 12, 2022
(86) PCT No.: PCT/EP2022/050526

§ 371 Date: Aug. 17, 2023

(30) Foreign Application Priority Data
Feb. 22, 2021 (DE) 10 2021 104 165.1

(51) Int. Cl. A61C 5/42; C21D 9/00; C22C 19/00; C22C 19/03

(52) U.S. Cl. CPC A61C 5/42; C21D 9/0068; C22C 19/007; C22C 19/03

(57) ABSTRACT

A method of producing a working area for a root canal instrument includes the steps of providing a strand made of a nickel-titanium alloy, cutting the strand to a blank size of the working area, forming a tip in the working area, heat-treating the working area at a temperature of 400 to 430° C. for 25 to 40 minutes, quenching the heat-treated working area to room temperature, and producing the final geometry of the working area, wherein the nickel-titanium alloy contains exclusively nickel and titanium as metal components.

### BACKGROUND

The present invention relates to a method of producing a working area for a root canal instrument and also to a method of producing a root canal instrument. Furthermore, the present invention also relates to a root canal instrument manufactured according to the methods.

Root canal instruments are known from the prior art, for example from DE 202012012526 U1. Root canal instruments must have a certain flexibility in order to be able to follow the bends and turns of a root canal so that a corresponding root canal treatment can be carried out. For this purpose, root canal instruments have a working area and a shaft area, wherein the shaft area (or shaft for short) acts as a handle area. The working area has a core, i.e. a solid material core, which continuously widens conically in the direction toward the shaft area. Molar teeth in particular have a relatively complicated root canal system in which the root canal instrument must also follow small radii of the root canal. For this purpose, the working area of the root canal instrument must be particularly flexible. Until now, this has been achieved by further tapering the core of the root canal instrument, which, however, leads to less mechanical stability of the working area and thus involves a certain risk of part of the working area breaking off during root canal treatment.

### SUMMARY

The object of the present invention is therefor that of providing a method of producing a working area for a root canal instrument, a method of producing a root canal instrument, and also a dental root canal instrument, wherein the root canal instrument is characterized by improved flexibility with a simple yet stable structure and in particular can also follow strong turns of a root canal of a tooth. The methods should also be simple and inexpensive to implement.

This object is achieved by a method of producing a working area for a root canal instrument, by a method of producing a root canal instrument, and by a root canal instrument having the features of the independent claims. The dependent claims show preferred embodiments of the invention.

For this purpose, the method according to the invention of producing a working area for a root canal instrument first comprises a step of providing a strand of a nickel-titanium alloy. A nickel-titanium alloy within the meaning of the present invention is understood to be an alloy which contains exclusively nickel and titanium as metal components and, in addition, substantially no other metallic components. “Substantially” in this context means except for technically unavoidable impurities, which, however, include quantity fractions of less than 0.1% by mass and, in particular, of less than 0.05% by mass, based on the total mass of the nickel-titanium alloy. However, the nickel-titanium alloy may contain non-metallic elements, compounds and/or components.

The nickel-titanium alloy strand is then cut to a blank size of the working area and a tip is then formed at one end of the strand in the working area to be produced. The forming of the tip is essential for the subsequent final geometry of the working area for the root canal instrument, as it must be shaped precisely and slimly to be suitable for insertion into a root canal. Shaping of the tip can be done, for example, by grinding, so that an essentially cylindrically shaped component with a tip at one end is produced.

Only then is the working area heat-treated at a temperature of 400 to 430° C. for 25 to 40 minutes. A temperature of 400° C. and a heat treatment duration of 30 minutes have proved to be particularly advantageous. However, the tip is still formed in a state of the nickel-titanium alloy in which the alloy is superelastic and hard, so that the tip can also be made very thin and at the same time breakage of the resulting tip can be prevented.

Subsequent heat treatment at a temperature of 400 to 430° C. for 25 to 40 minutes and subsequent quenching of the heat-treated working area to room temperature anneals the superelastic material and gives it a permanently high flexibility combined with high mechanical stability. Although annealing of nickel-containing titanium alloys at temperatures of around 300° C. is known, it has been found in accordance with the invention that only when heat treatment is carried out at temperatures above 400° C., namely from 400 to 430° C. and preferably at 400° C., for 25 to 40 minutes and in particular for 30 minutes, a material is formed which is optimally suited to the production of a working area for a root canal instrument, is very easy to handle and can be introduced even into highly angled root canals without breaking off. Temperatures of less than 400° C. have been found to be insufficient to combine the good application properties with the very good mechanical properties. In this case, the heat treatment can be carried out in particular in a suitable heating furnace, the internal temperature of which is maintained at 400° C. As an alternative to heat treatment in a furnace, the required heat can also be applied by a “resistive process”. In this case, a voltage is applied to the component to be heated, with the current flow being regulated to approx. 5 A per component. The component can be contacted with the voltage source via a mechanical sliding contact or alternatively via a conductive electrolyte.

Quenching at room temperature is carried out in particular to improve the flexibility of the working area, i.e. to increase its bending capacity, and also to improve the mechanical stability in terms of ductility, which in particular counteracts breakage of the working area under high torsional forces. For the purposes of the present invention, quenching is understood to mean quenching from the annealing temperature or the temperature of the heat treatment to room temperature, i.e. to about 20 to 25° C. This is achieved in particular by bringing the annealed or heat-treated nickel-titanium alloy into contact with a medium maintained at room temperature. The medium is not limited in detail and can include gases, such as nitrogen or carbon dioxide, or liquids, such as water and other inert solvents.

After annealing, the final geometry of the working area is produced, i.e., in particular, a conical shape tapering to the tip is formed from the cylindrical shape of the originally used strand, and any ablation surfaces that can be used for root canal cleaning are formed.

The method according to the invention can be implemented easily and cost-effectively and enables the production of a working area that is ideally suited for use in a root canal instrument and is characterized by a high degree of flexibility combined with a high degree of mechanical stability, so that it can easily follow the root canals without breaking off when used in a root canal treatment.

Advantageously, it is provided that the heat treatment is carried out by applying a resistive process.

According to an advantageous further development, the nickel-titanium alloy comprises carbon and/or oxygen as further components. These components can be present in elemental form, e.g. as pure carbon, or in the form of compounds, such as carbides or oxides. However, a content of carbon and/or oxygen is not essential, and the nickel-titanium alloy can also consist exclusively of nickel and titanium. Maximum contents of carbon on the one hand and oxygen on the other are 0.05% by mass each, based on the total mass of the nickel-titanium alloy.

Particularly preferably, the nickel-titanium alloy used for the method consists of 54 to 57% by mass nickel, a maximum of 0.05% by mass carbon, a maximum of 0.05% by mass oxygen and titanium as the remainder. The contents of hydrogen, oxygen and nitrogen are determined via carrier hot gas extraction (TGHE). The content of carbon is determined by combustion analysis and the content of all other elements is measured by X-ray fluorescence analysis (XRF).

As a particularly preferred material in terms of its shape memory, nitinol is used.

Further advantageously, the method comprises a step of rounding the working area after forming the tip and before heat treatment. Rounding, which can be carried out in particular by means of tumbling, enables sharp edges to be rounded off which are more difficult to rework after annealing or can only be reworked with a high loss of material.

Quenching is particularly advantageously carried out in water. It has been found that water, due to its high heat capacity, ensures particularly rapid cooling of the nickel-titanium alloy, which further improves both the bending capacity and the ductility of the working area.

The final geometry of the working area is produced in particular by grinding. Here, according to an advantageous further development, grinding may comprise grinding of a toothing and/or a depth mark. Serrations can help to better eliminate infected pulp tissue. Depth marks serve as an indication to the user of how deep the root canal instrument has been inserted into the root canal in order to prevent root canal treatment that goes too deep.

In particular, the depth mark is ground into an area discolored by the heat treatment and quenching, as this results in a very good color contrast, and the depth mark can be better visualized.

The method may comprise further method steps, such as deburring of the working area. Deburring can be performed, for example, by laser beams or water jets.

Further according to the invention, a method of manufacturing a root canal instrument is also described, which comprises the following steps. In a first method step, a working area for the root canal instrument is produced using the above method according to the invention of producing a working area for a root canal instrument, and the working area is then connected to a shaft. The shaft serves as a handle area for the user to guide the root canal instrument unerringly.

Preferably, the working area is joined to the shaft by pressing, welding or molding. In particular, the first two methods mentioned are especially suitable when the shaft is made of a metallic material. Direct molding of the shaft to the working area, i.e. to the end of the root canal instrument opposite the tip of the working area, is carried out in particular if the shaft is made of an injection-moldable plastic material. For example, an injection molding technique is used here.

Further advantageously, the method comprises a step of color marking and/or a step of mounting a stopper. Both variants serve to make it clear to the user of the root canal instrument how far he has inserted the root canal instrument into a root canal in order to prevent damage to the patient. The color marking or the stopper are attached to the root canal instrument where deeper insertion into the root canal is to be prevented.

Furthermore, according to the invention, a dental root canal instrument is also described which can be manufactured by the above method of manufacturing a root canal instrument. Due to the application of the method according to the invention, the root canal instrument according to the invention is characterized by an excellent flexibility and at the same time high mechanical stability. As a result, when treating a root canal, the bends and turns of the root canal can be followed excellently with the root canal instrument according to the invention, even in the case of molar root canals that are difficult to access, without any risk of the working area of the root canal instrument breaking off. This means that dead or infected pulp tissue can be completely removed from the root canal with a high degree of certainty. This results in the greatest possible elimination of microorganisms which are present in the root canal.

The advantages, advantageous effects and further developments described for the methods according to the invention and the root canal instrument according to the invention are mutually applicable in each case. In addition, reference is made to the above explanations with regard to any definitions.

### BRIEF DESCRIPTION OF THE DRAWINGS

In the following, the invention is described by means of an embodiment example in connection with the drawing. The FIGURES show in:

FIG. 1 a schematic side view of a root canal instrument according to one embodiment of the invention.

### DETAILED DESCRIPTION

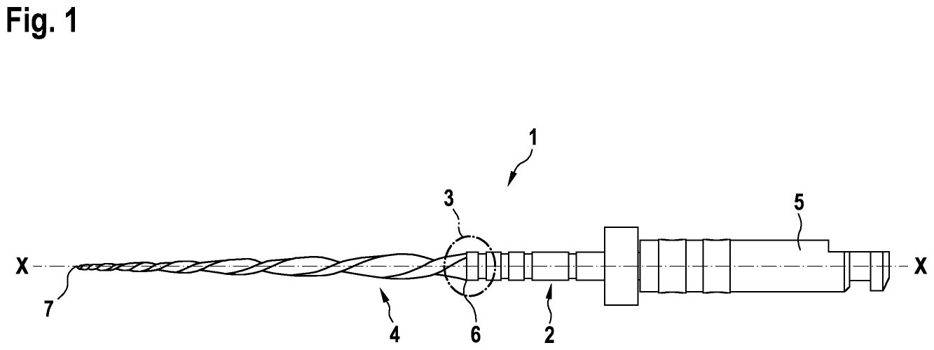

FIG. 1 shows in detail a root canal instrument 1 produced according to the method of producing a root canal instrument according to the invention, comprising a shaft 2 and a working area 4 connected to the shaft 2 by a connection area 3. A connection piece 5 is located at a distal end of the shaft 2. The connection piece 5 is used for connection to a drive or also a handpiece with which a dentist can operate the root canal instrument 1.

The working area 4 is to be regarded as a cutting area with which dead or bacterially infected pulp tissue of a root canal can be removed. The working area 4 comprises a first end 6 and a second end 7. The first end 6 is connected to the shaft 2 in the connection area 3, while the second end 7 is exposed and comprises a tip. Overall, the course of the working area 2 from the first end 6 to the second end 7 is more or less conical, wherein the working area 2 comprises a plurality of areas in the axial direction X-X that are provided with different twist angles, wherein the twist angles decrease from the first end 6 to the second end 7.

The working area 4 consists of a nickel-titanium alloy consisting in particular of 54 to 57 mass % nickel, a maximum of 0.05 mass % carbon, a maximum of 0.05 mass % oxygen, and the balance titanium. The working area 4 was obtained by cutting a strand of the nickel-titanium alloy to a blank size of the working area, forming a tip in the working area, heat treating the working area at a temperature of 400 to 430° C. for 25 to 40 minutes and in particular at 400° C. for 30 minutes, quenching the heat treated working area to room temperature and producing the final geometry of the working area. Here, the heat treatment, which was carried out in a furnace as an example, and the subsequent quenching, which was carried out using water kept at room temperature (20 to 25° C.), were essential for obtaining a highly flexible but mechanically stable working area, which was joined to the shaft 2 after the final geometry was produced.

As an alternative to heat treatment in a furnace, the required heat can also be applied via a “resistive process”. In this case, a voltage is applied to the component to be heated, with the current flow being regulated to approx. 5 A per component. The component can be contacted with the voltage source via a mechanical sliding contact or alternatively via a conductive electrolyte.

### LIST OF REFERENCE CHARACTERS

1 root canal instrument
2 shaft
3 connection area
4 working area
5 connection piece
6 first end
7 second end

1. A method of manufacturing a working area for a root canal instrument comprising the steps:
providing a strand made of a nickel-titanium alloy
cutting the strand to a blank size of the working area
forming a tip in the working area
heat-treating the working area at a temperature of 400 to 430° C. for 25 to 40 minutes
quenching of the heat-treated working area to room temperature; and
producing a final geometry of the working area
wherein the nickel-titanium alloy contains exclusively nickel and titanium as metal components.

2. The method according to claim 1, wherein the heat treatment is carried out by applying a resistive process.

3. The method according to claim 1, wherein the nickel-titanium alloy comprises carbon and/or oxygen as further components.

4. The method according to claim 1, wherein the nickel-titanium alloy consists of 54 to 57 mass % nickel, a maximum of 0.05 mass % carbon, a maximum of 0.05 mass % oxygen, and the balance titanium.

5. The method according to claim 1, further comprising a step of rounding the working area after forming the tip and before heat treatment.

6. The method according to claim 1, wherein the quenching is carried out in water.

7. The method according to claim 1, wherein producing the final geometry of the working area comprises grinding a toothing and/or a depth mark.

8. The method according to claim 7, wherein the depth mark is ground into an area discolored by the heat-treating and quenching.

9. The method of manufacturing a root canal instrument, comprising the steps:
producing a working area for the root canal instrument according to the method of claim 1, and
connecting the working area to a shaft.

10. The method according to claim 9, wherein the connection of the working area to the shaft is carried out by pressing, welding or molding.

11. The method according to claim 9, further comprising a step of color marking and/or a step of mounting a stopper.

12. A root canal instrument manufactured by a method according to claim 9.
